(19) United States
(12) Patent Application Publication
(10) Pub. No.: US 2021/0120903 A1
(43) Pub. Date: Apr. 29, 2021

(54) Headwear Retainer

(71) Applicant: Joseph Berengher Brechtel, III, Covington, LA (US)

(72) Inventor: Joseph Berengher Brechtel, III, Covington, LA (US)

(21) Appl. No.: 16/665,878

(22) Filed: Oct. 28, 2019

(51) Int. Cl. A42B 1/24

(52) U.S. Cl. CPC A42B 1/247

(57) ABSTRACT

A hat retainer that secures headwear without the use of cables, ropes or clips. This retainer provides the above in a practical and comfortable manner for all types of headwear.

### BACKGROUND OF THE INVENTION

### 1. Field of the Invention

The present invention relates to a headwear retainer which allows headwear to be secured in the position of use; when not in direct use, to be worn on the arm of sunglasses without falling off or being damaged.

### 2. Description of the Related Art

Many people wear headwear, such as baseball caps, fishing hats, farm hats, construction helmets etc. for keeping the sun off, protection, fashion purposes, or for pleasure. However, normal use of headwear is problematic as it often gets lost, misplaced, or falls off the user. For example, on a boat ride or fishing trip, a common occurrence is wind blowing the hat from the user's head. In some cases, the user will take the headwear off. However, taking the headwear off during situations has the disadvantage that people will often forget where they have placed their headwear. Such removal also causes the user to experience sun on their heads and wind making their hair messy. When headwear stays on during intense activities, the headwear often falls off and is lost.

Alternatively, it is also common to see people securing their headwear with devices using cables, ropes, and clips. However, such devices and clips are inconvenient or unusable during certain activities, the cables, ropes, and clips snag during a variety of activities. Furthermore, having devices and clips using cable and rope is quite inconvenient, given that the cables and ropes get snagged and pulled off; other devices using a cable and retraction mechanism are heavy, uncomfortable and still get snagged and pulled in their positions of use. Moreover, when engaging in sports or outdoor activities the cables and ropes get snagged and pulled off. Additionally, the headwear can be pulled off causing injury if one should fall. As such, it is common to see people wear their headwear as tight as possible, but of course, this too is problematic as it often is uncomfortable, leads to headaches, and the headwear still falls after sweat lubricates the headwear. Furthermore, it is common to see people use anti-skid attachments on the arm of eyewear, however this provides no additional traction when worn under headwear instead it's used to secure eyewear around the ear of the user.

In these regards, none of the prior art solutions offer a way to avoid the above described problems.

### SUMMARY OF THE INVENTION

It is therefore an object of the present invention to, among others, overcome the deficiencies in the prior art such noted above.

It is also an object of the present invention to provide a headwear retainer that is comfortable and convenient to constantly use, of no maintenance, and offers a practical yet low profile for daily use. In this regard, the present invention permits headwear to be retained by attaching the invention on the arm of eyewear; the arm of the eyewear is placed under the headwear but also allows the user to keep the retainer on their eyewear while not in direct use, to be performed by a single movement. It causes no hinderance during activities such as fishing, hunting, sports, as it has no cables, rope, or clips and is low profile, highly durable, comfortable, produced at low cost, and its operation during direct and indirect use can be easily controlled. The present invention is advantageous in that it may allow a user to retain their headwear without cables, ropes, straps, and clips, and is especially useful for all active users, such as fisherman, hunters, athletes, construction workers, law enforcement, etc. to this end, the invention may be used on all manner of headwear, baseball caps, fishing hats, construction hats, visors, and fits on ail sizes of eyewear.

Additional advantages and other novel features of the invention will be set forth in part in the description that follows and in part will become apparent to those skilled in the art upon examination of the following or may be learned with use of the invention.

### BRIEF DESCRIPTION OF THE DRAWINGS

The accompanying drawings, which are incorporated in and constitute a part of the specification, illustrate a preferred embodiment of the invention and, together with the general description above, and the detailed description of the preferred embodiment given below, serve to explain the principles and best mode of the invention.

FIG. 1 is an elevated view and is an embodiment of the headwear retainer surrounding the arm of eyewear, during indirect use.

FIG. 2 is a side view of the user wearing the headwear retainer and utilizing an embodiment of the invention, while the retainer in its position of use.

### DETAILED DESCRIPTION OF THE PREFERRED EMBODIMENTS

In its broadest embodiment, the present invention relates to a headwear retainer comprising: two retainers, each having a cavity made on one end respectively surrounding the arm of eyewear, and texture or grips applied to the full outer surface of the retainer having contact with the user and the headwear. Furthermore, the texture or grips grasps the headwear, when placed under headwear in the position of use.

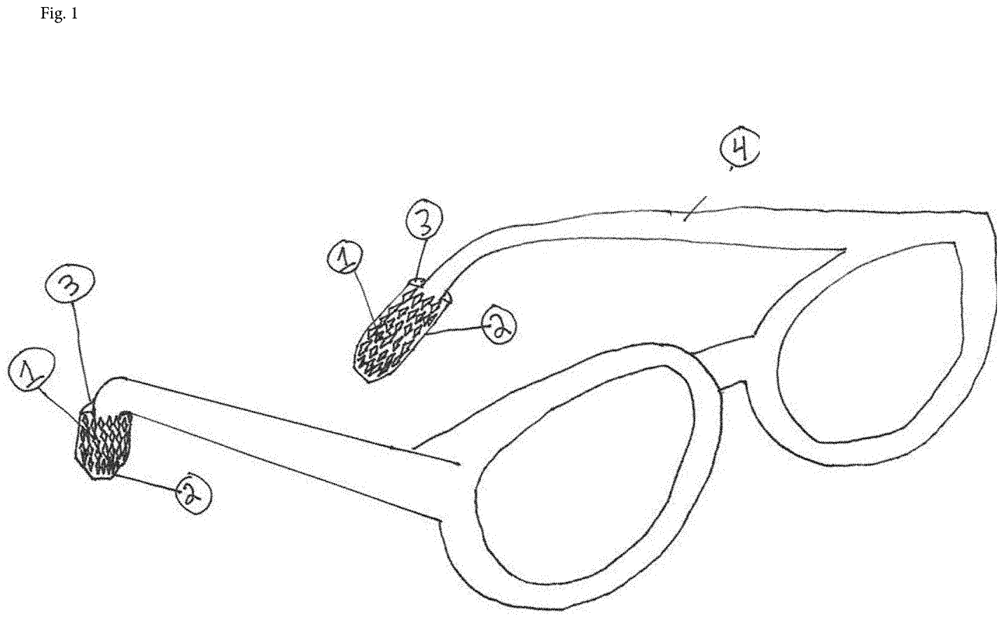

Details to the present preferred embodiment of the invention will now be made as illustrated in the drawings. FIG. 1 illustrates the present invention during non-direct use on the arm of eyewear 4, the best form for the retainer 2 is flat it provides the most surface area; the best texture or grips 1 used on the outer surface of the retainer 2, is a horizontal diamond texture 1. A horizontal diamond texture 1 is the preferred embodiment of the present invention it provides the best grasps to mesh, straw, rubber and cloth headwear while maintaining a low profile and comfortability. Additionally, the horizontal diamond texture 1 is best added during the molding process and engraved to the retainer, engraving is best for durability. Furthermore, the arm of the eyewear 4 is attached in the retainer's cavity 3; the horizontal diamond texture 1 expands during this action. The cavity 3 expands to securely fasten around the arm of eyewear 4. The cavity 3 is best made during the molding process. The best materials to make the retainer 2 are silicone or a soft rubber like material; such materials provide the best durability, comfortability, elasticity and expandability.

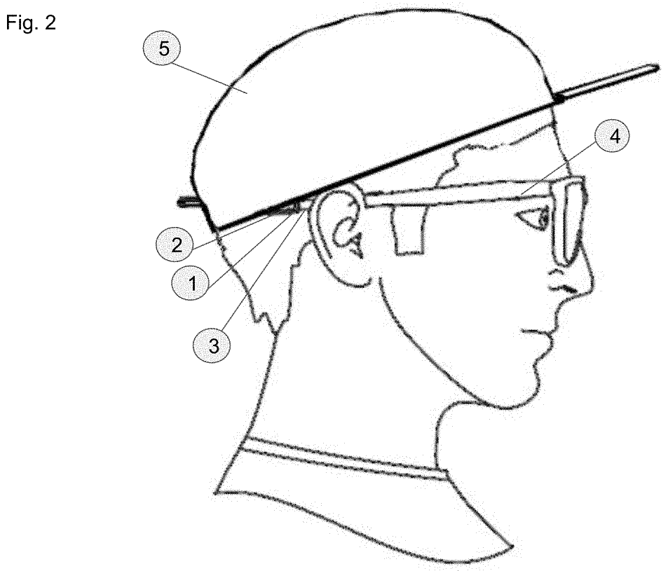

FIG. 2 is a side view of the same preferred present embodiment in FIG. 1 but with the user utilizing the invention while in the position of use. Moreover, the retainer's cavity 3 is attached, surrounding the arm of eyewear 4; the retainer 2 with a horizontal diamond texture 1 is expanded when attached to the arm of eyewear 4. The retainer 2 is placed under the headwear 5 in a secure fashion, the horizontal diamond texture 1 grasp the headwear 5 to prevent loss of said headwear 5. The headwear retainer 2 will not be pulled or snagged by anything as the retainer 2 is not connected by any cables, ropes, and clips. The horizontal diamond texture 1 entangles with cloth materials inside headwear 5, grasps with plastic and mesh headwear 5, and securely grasps to stitching around the inside perimeter of headwear, preventing said headwear 5 from falling off. Lastly, those skilled in the art may change the size, or texture of the present embodiment of the invention without departing from the spirit thereof.

1. A headwear retainer comprising:
A pair of retainers attached to the arm of eyewear, wherein at least a substantial portion of the retainers' outer surface has texture or grips.

2. A headwear retainer according to claim 1, wherein the texture or grips is applied to the outer surface.

3. A headwear retainer according to claim 2, wherein the texture or grips is engraved or embedded.

4. A headwear retainer according to claim 1, wherein the texture or grips expand, when attached to the arm of eyewear.

5. A headwear retainer according to claim 1, wherein the retainer includes a cavity for attaching the retainer to the arm of eyewear.

6. A headwear retainer according to claim 5, wherein the cavity is one end of each retainer.

7. A headwear retainer according to claim 5, wherein the retainer cavity expands around the arm of eyewear.

8. A headwear retainer according to claim 7, wherein the retainer expands to securely fasten said retainer to the arm of eyewear.

9. A headwear retainer according to claim 1, wherein the retainer material is expandable and exhibits elasticity.
